(19) United States
(12) Patent Application Publication
(10) Pub. No.: US 2025/0180816 A1
(43) Pub. Date: Jun. 5, 2025

(54) FIBER ROUTING ARRANGEMENT STRUCTURALLY CONFIGURED TO PROVIDE ROUTING FOR OPTICAL FIBERS IN A FIBER MANAGEMENT SYSTEM SO AS TO ENHANCE EXPANSION OF THE FIBER MANAGEMENT SYSTEM

(71) Applicant: PPC BROADBAND, INC., East Syracuse, NY (US)

(72) Inventors: Andreas LEYER, Potsdam (DE); Karl FLEMMING, Teltow (DE)

(73) Assignee: PPC BROADBAND, INC., East Syracuse, NY (US)

(21) Appl. No.: 18/963,971

(22) Filed: Nov. 29, 2024

Related U.S. Application Data
(60) Provisional application No. 63/605,217, filed on Dec. 1, 2023.

(51) Int. Cl. G02B 6/36

(52) U.S. Cl. CPC G02B 6/3616

(57) ABSTRACT

A fiber routing arrangement configured to route optical fibers between modules of a fiber management system so as to enhance expansion of the fiber management system includes: a fiber entry portion including first, second, and side edge fiber passages; and a fiber bridge including a bridge first fiber passage. The various fiber passages are structurally configured to provide a passage for an optical fiber from an area outside of a fiber management system to an area of the fiber management system that is below the fiber entry portion, to provide a passage for the optical fiber from an area outside of the fiber management system to an area of the fiber management system that is located adjacent to the side edge fiber passage portion, and to provide passage for the optical fiber from an area outside of a fiber management system to an area of the fiber management system that is above the fiber entry portion.

### CROSS-REFERENCE TO RELATED APPLICATION

This application claims the benefit of U.S. Provisional Patent Application No. 63/605,217, filed on Dec. 1, 2023, the disclosure of which is hereby incorporated by reference herein in its entirety.

### BACKGROUND

The present invention relates generally to cable management systems, and more particularly to optical fiber management and routing systems.

Some optical fiber management systems have long paths for the optical fibers and difficult assembling time due to guiding fibers from one column of a multi-column arrangement to the next column. This can be especially true in arrangements where different columns have a different number of cassette/module supports and/or that contain more than two columns.

It may be desirable to provide a fiber routing arrangement that is structurally configured to facilitate routing of optical fibers in a fiber management system to enhance expansion of the fiber management system.

### SUMMARY

In arrangements having more than one column, embodiments allow flexible routing of optical fibers while traversing between the columns and provide entries and exists where most beneficial. This can result in a higher density, more flexibility, shorter fibers runs, and a reduction of assembly time. Embodiments provide essentially infinite expansion of columns including flexibility in fiber entry and exit locations of each column.

Embodiments provide a fiber routing arrangement structurally configured to route optical fibers between modules of a fiber management system so as to enhance expansion of the fiber management system including: a fiber entry portion including a base portion; a first edge fiber passage portion structurally configured to provide a passage for an optical fiber; a second edge fiber passage portion structurally configured to provide a passage for the optical fiber; a side edge fiber passage portion structurally configured to provide a passage for the optical fiber; and a first guide portion structurally configured to guide the optical fiber in the fiber entry portion; a fiber bridge portion including a central portion structurally configured to be located between a first end portion and a second end portion; a bridge first fiber passage portion between the first end portion and the central portion; and a bridge second fiber passage portion between the second end portion and the central portion. The first edge fiber passage portion may be on a first edge portion of the base portion; the second edge fiber passage portion may be on a second edge portion of the base portion; the second edge portion may be opposite the first edge portion; the side edge fiber passage portion may be on a side edge portion of the base portion, the side edge portion being an edge other than the first edge portion or the second edge portion; the side edge fiber passage portion may be structurally configured to provide a passage for the optical fiber from the fiber entry portion to a location outside of the fiber entry portion through the side edge portion; the fiber bridge portion may be structurally configured to be connected to a first module of a fiber management system located on a first side of the fiber bridge portion; the fiber bridge portion may be structurally configured to be connected to a second module of the fiber management system located on a second side of the fiber bridge portion, the second side being opposite the first side; the bridge first fiber passage portion may be structurally configured to facilitate passage of the optical fiber from between the first module and the second module; the bridge first fiber passage portion and the bridge second fiber passage portion may be structurally configured to provide routing of the optical fiber between the first module and the second module of the fiber management system; the first edge fiber passage portion, the second edge fiber passage portion, and the side edge fiber passage portion may be structurally configured to provide a passage for the optical fiber from an area outside of a fiber management system to an area of the fiber management system that is below the fiber entry portion, to provide a passage for the optical fiber from an area outside of the fiber management system to an area of the fiber management system that is located adjacent to the side edge fiber passage portion, and to provide a passage for the optical fiber from an area outside of a fiber management system to an area of the fiber management system that is above the fiber entry portion; and the fiber entry portion and the fiber bridge portion may be structurally configured to provide routing of the optical fiber between the first module and the second module of the fiber management system so as to enhance expansion of the fiber management system.

In particular embodiments, the fiber entry portion may further comprise a second guide portion structurally configured to guide the optical fiber in the fiber entry portion.

In particular embodiments, the fiber entry portion may further comprise a first fiber retention portion structurally configured extend from the first guide portion and to retain the optical fiber on the fiber entry portion.

In particular embodiments, the first edge fiber passage portion may be structurally configured to provide a passage for the optical fiber from the fiber entry portion to a location outside of the fiber entry portion through the first edge portion of the base portion.

In particular embodiments, the bridge second fiber passage portion may be structurally configured to provide a passage for the optical fiber from between the first module and the second module.

In particular embodiments, the fiber bridge portion may be structurally configured to be located between a first one of the fiber entry portion located on a first stack of modules and a second one of the fiber entry portion located on a second stack of modules.

In particular embodiments, the base portion may be structurally configured as a base plate.

In particular embodiments, the first edge portion may be structurally configured as a top edge of the base portion, the side edge portion is structurally configured as a side edge of the base portion, and the side edge portion is perpendicular to the top edge portion.

In particular embodiments, the fiber entry portion may be structurally configured to be connected directly to a module at an end of a first stack of the modules.

Embodiments provide a fiber routing arrangement structurally configured to route optical fibers between modules of a fiber management system so as to enhance expansion of the fiber management system including: a fiber entry portion including a first edge fiber passage portion structurally configured to provide a passage for an optical fiber; a side edge fiber passage portion structurally configured to provide a passage for the optical fiber; and a fiber bridge portion including a bridge first fiber passage portion. The first edge fiber passage portion may be on a first edge portion of the fiber entry portion; the side edge fiber passage portion may be on a side edge portion of the fiber entry portion, the side edge portion being an edge other than the first edge portion; the side edge fiber passage portion may be structurally configured to provide a passage for the optical fiber from the fiber entry portion to a location outside of the fiber entry portion; the fiber bridge portion may be structurally configured to be connected to a first module of a fiber management system located on a first side of the fiber bridge portion; the fiber bridge portion may be structurally configured to be connected to a second module of the fiber management system located on a second side of the fiber bridge portion, the second side being opposite the first side; the bridge first fiber passage portion may be structurally configured to facilitate a passage for the optical fiber between the first module and the second module; the first edge fiber passage portion and the side edge fiber passage portion may be structurally configured to provide a passage for the optical fiber from an area outside of a fiber management system to an area of the fiber management system that is below the fiber entry portion, to provide a passage for the optical fiber from an area outside of the fiber management system to an area of the fiber management system that is located adjacent to the side edge fiber passage portion, and to provide passage for the optical fiber from an area outside of a fiber management system to an area of the fiber management system that is above the fiber entry portion; and the fiber entry portion and the fiber bridge portion may be structurally configured to provide routing of the optical fiber between the first module and the second module of the fiber management system so as to enhance expansion of the fiber management system.

In particular embodiments, the fiber entry portion may further comprise a base portion, and the first edge fiber passage portion is on a first edge portion of the base portion.

In particular embodiments, the fiber edge portion may further comprise a second edge fiber passage portion structurally configured to provide a passage for the optical fiber.

In particular embodiments, the second edge fiber passage portion may be on a second edge portion of the base portion, and the second edge portion is opposite the first edge portion.

In particular embodiments, the fiber bridge portion may further comprise a central portion structurally configured to be located between a first end portion and a second end portion, and the bridge first fiber passage portion may be structurally configured between the first end portion and the central portion.

In particular embodiments, the fiber bridge portion may further comprise a bridge second fiber passage portion structurally configured between the second end portion and the central portion.

Embodiments provide a fiber entry portion structurally configured to provide an entry point for optical fibers into a fiber management system so as to enhance expansion of the fiber management system including: a first edge fiber passage portion structurally configured to provide a passage for an optical fiber; and a side edge fiber passage portion structurally configured to provide a passage for the optical fiber. The first edge fiber passage portion may be on a first edge portion of the fiber entry portion; the side edge fiber passage portion may be on a side edge portion of the fiber entry portion, the side edge portion being an edge other than the first edge portion; the side edge fiber passage portion may be structurally configured to provide a passage for the optical fiber from the fiber entry portion to a location outside of the fiber entry portion; the first edge fiber passage portion and the side edge fiber passage portion may be structurally configured to provide a passage for the optical fiber from an area outside of a fiber management system to an area of the fiber management system that is below the fiber entry portion, to provide a passage for the optical fiber from an area outside of the fiber management system to an area of the fiber management system that is located adjacent to the side edge fiber passage portion, and to provide a passage for the optical fiber from an area outside of a fiber management system to an area of the fiber management system that is above the fiber entry portion; and the fiber entry portion may be structurally configured to provide routing of the optical fiber between stacks of modules in the fiber management system so as to enhance expansion of the fiber management system.

In particular embodiments, the fiber entry portion may further comprise a base portion, and the first edge fiber passage portion may be structurally configured to be on a first edge portion of the base portion.

In particular embodiments, the fiber edge portion may further comprise a second edge fiber passage portion structurally configured to provide a passage for the optical fiber.

In particular embodiments, the second edge fiber passage portion may be structurally configured on a second edge portion of the base portion, and the second edge portion is opposite the first edge portion.

In particular embodiments, a second edge portion of the fiber entry portion may be structurally configured to be connected directly to a module at an end of a first stack of the modules.

In particular embodiments, the side edge portion of the fiber entry portion may be structurally configured to be located adjacent to a fiber bridge located at a side of the first stack of the modules.

Although embodiments of the disclosure are described with reference to a fiber entry point and a fiber bridge of an optical fiber management system, the features of the disclosure are also applicable to management of other cables and wires.

Various aspects of the fiber entry point and fiber bridge, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a front view of an exemplary fiber management system including a plurality of fiber entry points in accordance with various aspects of the disclosure and a plurality of fiber bridges in accordance with various aspects of the disclosure.

FIG. 2 is a perspective view of an exemplary fiber entry point in accordance with various aspects of the disclosure.

FIG. 3 is a bottom view of the fiber entry point of FIG. 2.

FIG. 4 is a rear view of the fiber entry point of FIG. 2.

FIG. 5 is a front view of the fiber entry point of FIG. 2.

FIG. 6 is a perspective view of an exemplary fiber bridge in accordance with various aspects of the disclosure.

FIG. 7 is a front view of fiber bridge of FIG. 6.

FIG. 8 is a sectional view of the fiber bridge of FIG. 6 taken at section line VIII-VIII in FIG. 7.

FIG. 9 is a rear view of the fiber bridge of FIG. 6.

FIG. 10 is a front view of the fiber entry point of FIG. 2 connected to an exemplary cassette mount.

FIG. 11 is a front view of an exemplary fiber management system including a plurality of the fiber entry point of FIG. 2 and a plurality of the fiber bridge of FIG. 6.

FIG. 12 is a front view of the exemplary fiber management system of FIG. 1 showing exemplary fiber routing.

FIG. 13 is a perspective view of an exemplary fiber entry point in accordance with various aspects of the disclosure.

FIG. 14 is a front view of the fiber entry point of FIG. 13.

FIG. 15 is a rear view of the fiber entry point of FIG. 13.

### DETAILED DESCRIPTION OF EMBODIMENTS

Embodiments provide a fiber entry portion having a first edge fiber passageway, a second edge fiber passageway, and a side edge fiber passageway that are structurally configured to be positioned as part of a fiber management system to facilitate routing of optical fibers between multiple stacks of modules in the fiber management system.

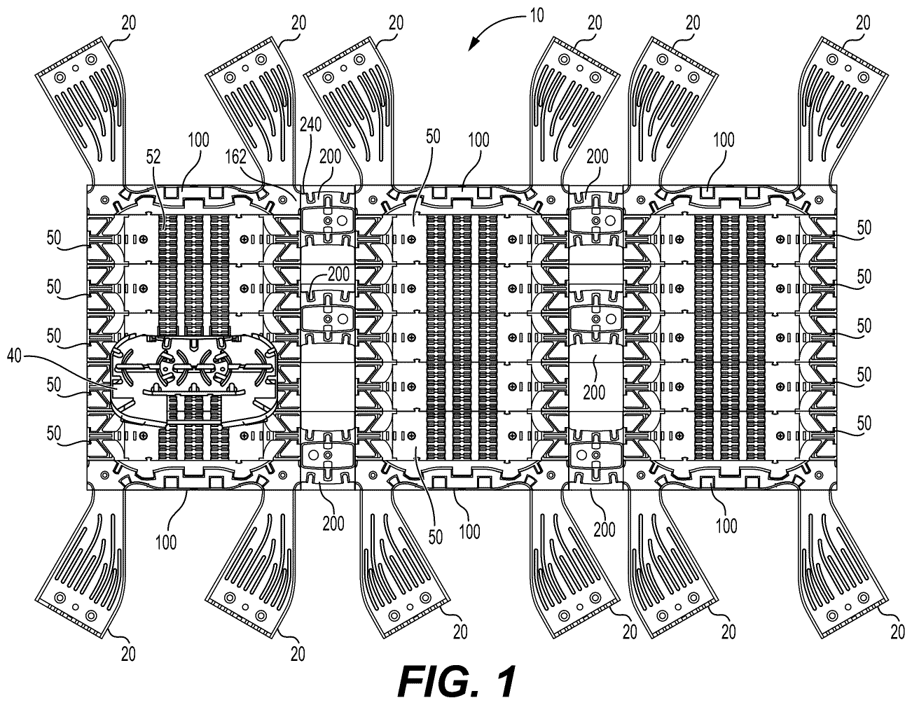

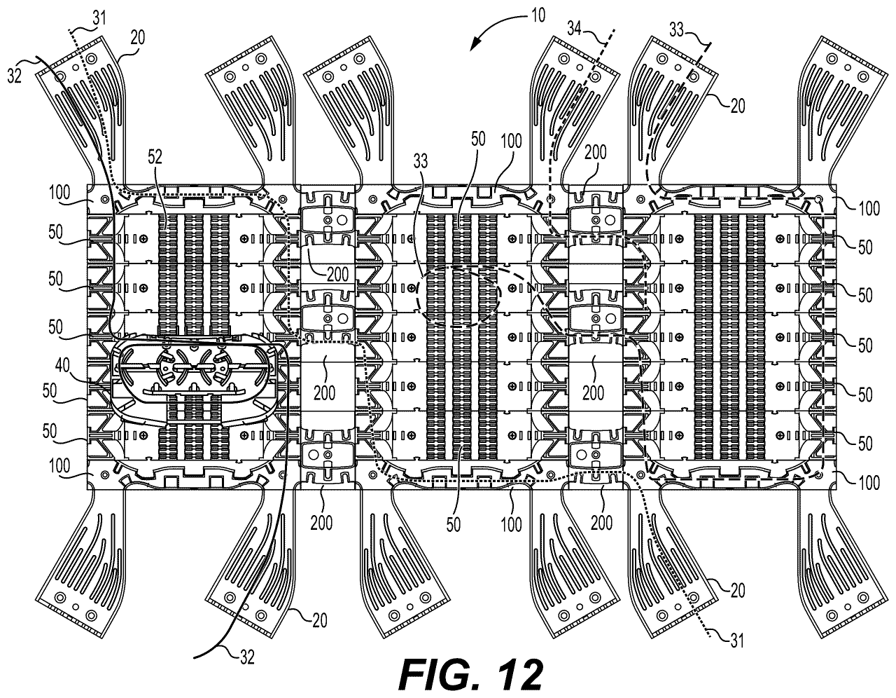

FIG. 1 shows an exemplary fiber management system 10 including embodiments of the invention. The fiber management system 10 includes a plurality of cable guides 20 that are configured to guide one or more optical fibers to one of a plurality of cassettes/modules such as, for example, cassette 40, on which splicing or other operations can be conducted. FIG. 12 shows some exemplary cables 31, 32, 33, 34 routed on and/or through the system 10. In the example shown in FIG. 1, a plurality of cassette mounts 50 are connected to each other in a number of, in this example, three, columns that are arranged parallel to each other. Each cassette mount 50 is configured to hold one or more of the cassette 40 such the cassette 40 can pivot relative to the cassette mount 50 around a cassette attachment portion 52.

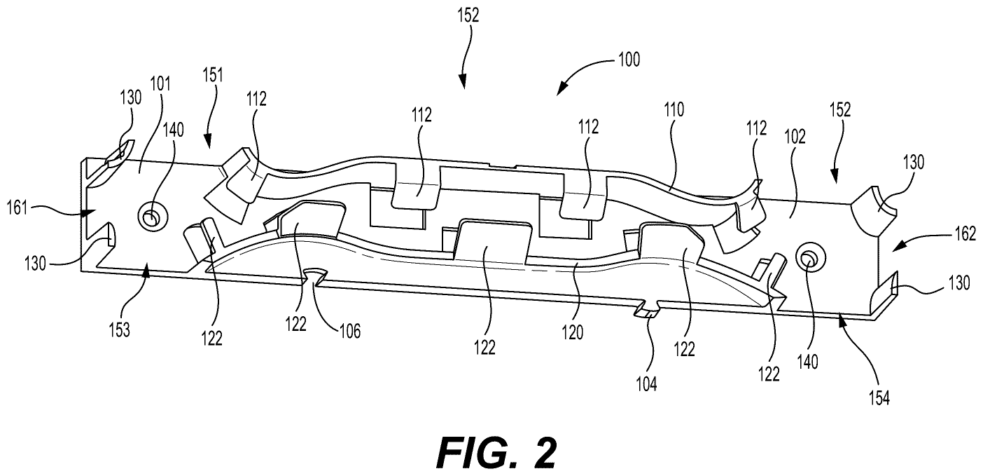

Also shown in FIG. 1 are a plurality of fiber entry portions 100 that are, in this example, located at the top and bottom of each column of the cassette mounts 50 and serve as fiber passageways into and out of the columns (described in more detail below). In other embodiments, a fiber entry portion 100 is located at only the top or only the bottom of one or more of the columns. Also shown in FIG. 2 are a plurality of fiber bridge portions, for example, fiber bridges, 200. In this example, the fiber bridges 200 are positioned between the columns and serve as fiber passageways between the columns (described in more detail below).

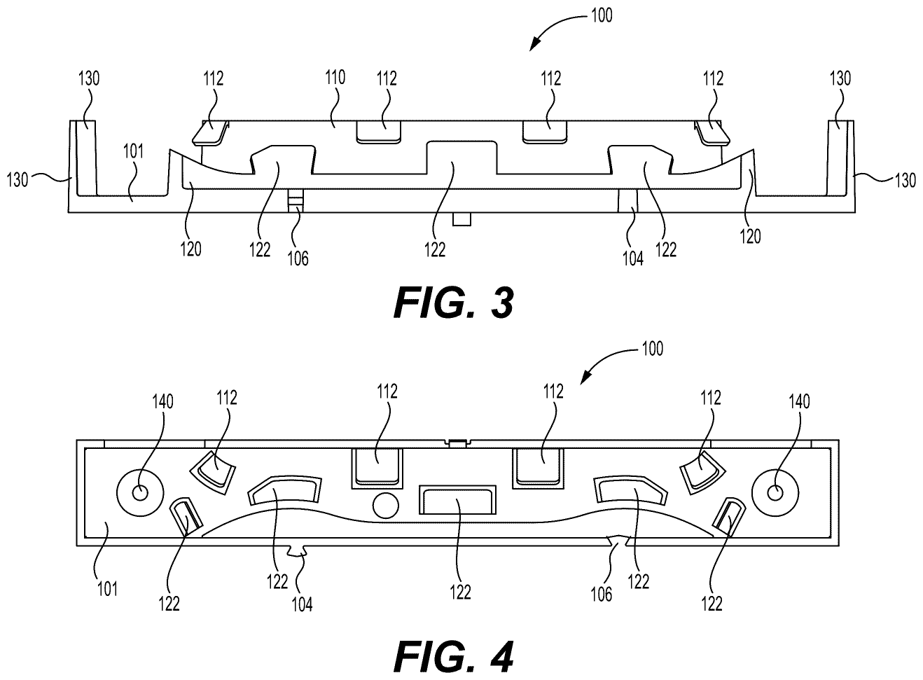

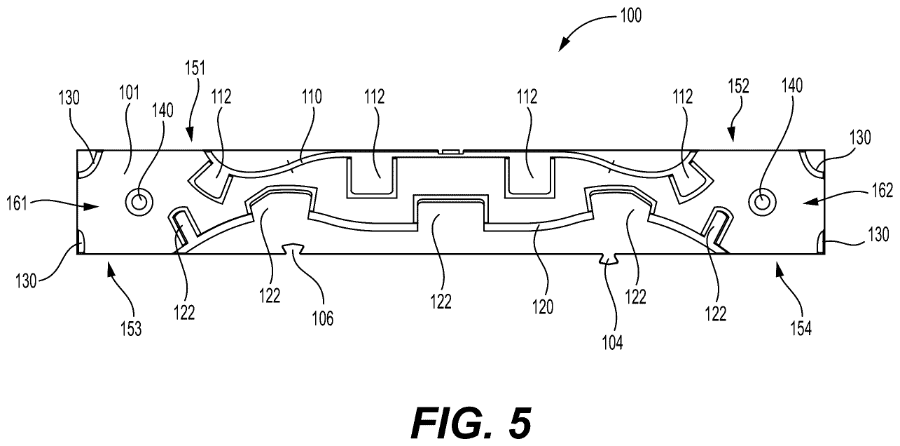

FIGS. 2-5 show an example of the fiber entry portion 100 that has a base portion, for example, a back plate, 101 from which a first guide portion, for example, a first fiber guide, 110 and a second guide portion, for example, a second fiber guide, 120 extend. In this example, the first fiber guide 110 has a plurality of fiber retention portions 112 extending therefrom. In this example, the fiber retention portions 112 extend from the first fiber guide 110 in a direction substantially parallel to the back plate 101. In this example, the second fiber guide 120 has a plurality of fiber retention portions 122 extending therefrom. In this example, the fiber retention portions 122 extend from the second fiber guide 120 in a direction substantially parallel to the back plate 101. The first fiber guide 110 and the second fiber guide 120 form a fiber pathway configured to retain optical fibers, or other cables/wires.

A pair of openings, for example, first edge fiber passageways, 151, 152 are located at the top of the fiber entry portion 100 and provide, for example, entry/exit locations for optical fibers routed into/out of the fiber entry portion 100 and, in turn, into/out of a cassette mount 50 and/or a fiber bridge 200. A pair of openings, for example, second edge fiber passageways, 153, 154 are located at the bottom of the fiber entry portion 100 and provide, for example, entry/exit locations for optical fibers routed into/out of the fiber entry portion 100 and, in turn, into/out of a cassette mount 50. A pair of openings, for example, side edge fiber passageways, 161, 162 are located at the sides of the fiber entry portion 100 and provide, for example, entry/exit locations for optical fibers routed in the fiber entry portion 100 and, in turn, into/out of a cassette mount 50 and/or a fiber bridge 200.

In this example, a plurality of end guide portions 130 extend from the back plate 101 and, in this example, define side edge fiber passageways 161, 162 that are structurally configured to guide optical fibers between the fiber entry portion 100 and a fiber bridge 200 (see FIG. 1).

In this example, the fiber entry portion 100 has two attachment portions, for example, mounting openings, 140 for receiving a mounting hardware such as, for example, screws or bolts. Also shown in FIG. 2 are a first connection portion, for example, a connection protrusion, 104, and a second connection portion, for example, a connection recess 106. The connection protrusion 104 and the connection recess 106 are structurally configured to engage oppositely configured portions on, for example, a cassettes mount 50 located below the fiber entry portion 100. In some embodiments, similar connection portions are also located on the top edge of the fiber entry portion 100.

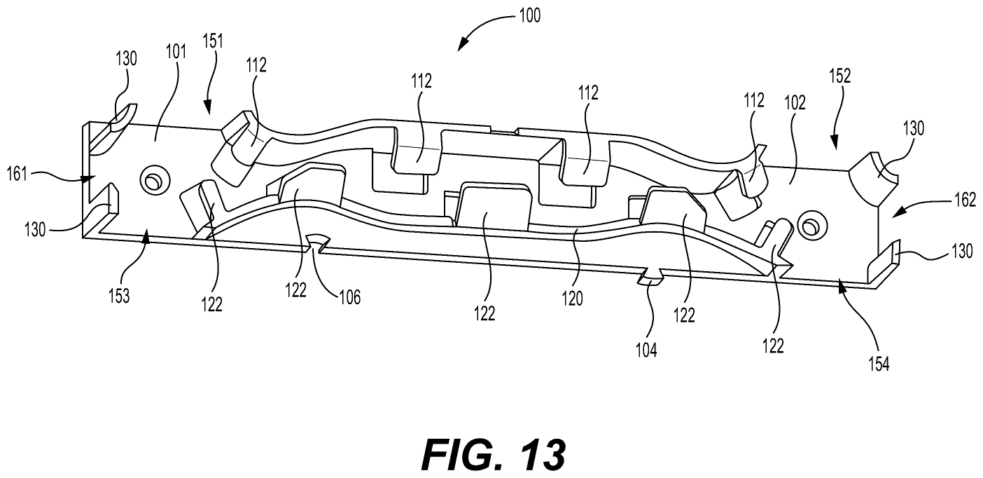

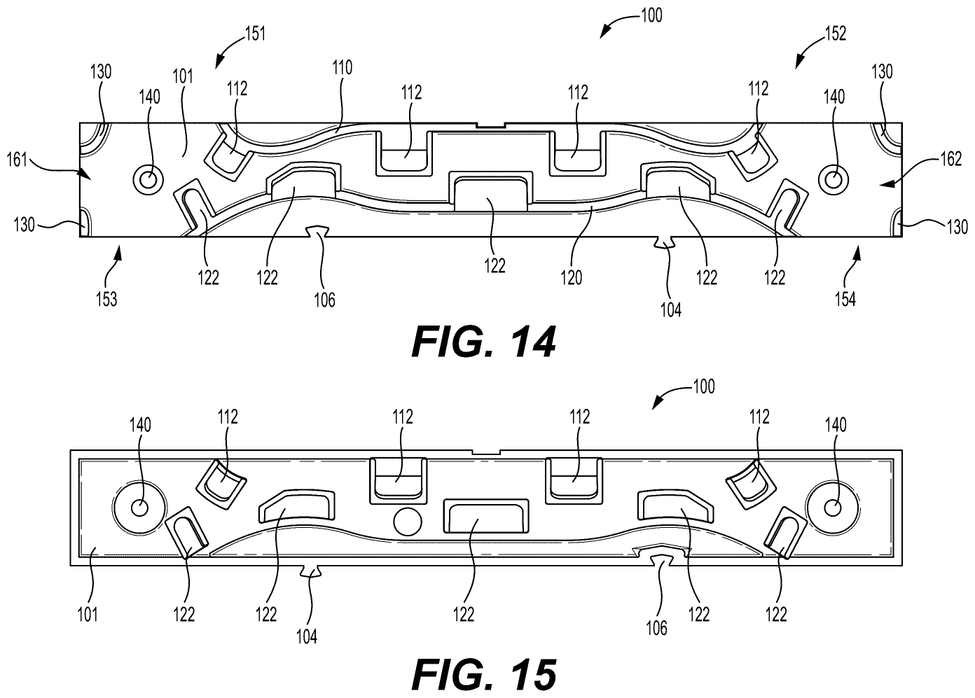

FIGS. 13-15 show an alternate embodiment of the fiber entry portion 100 having, among other features, different shaped and/or angled fiber retention portions 112 and 122. In embodiments, one or more of the fiber retention portions 112 and 122 has an angled end portion, as shown on the fiber retention portions 112 in FIGS. 13-15, that is configured to help keep fibers/cables close to the first fiber guide 110 or the second fiber guide 120.

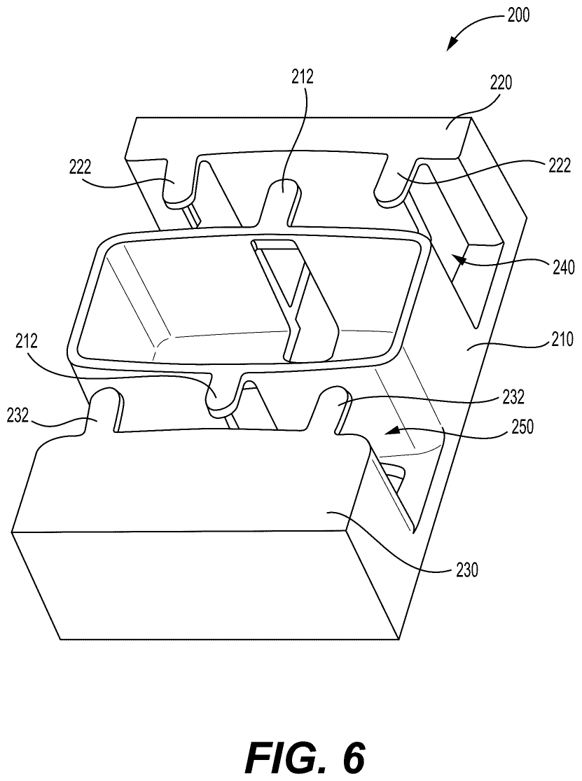

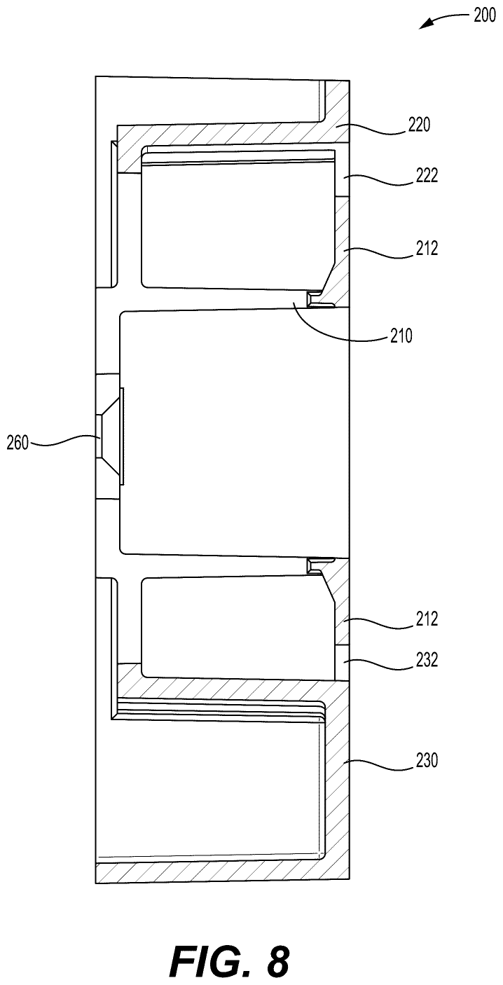

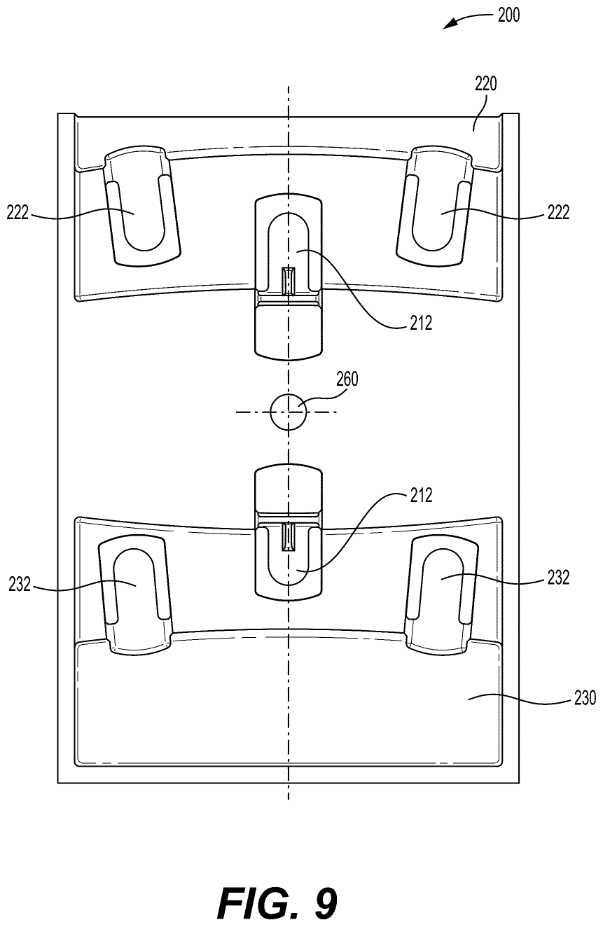

FIGS. 6-9 shows an example of the fiber bridge 200 having a central portion 210, a first end portion 220, and a second end portion 230. The central portion 210 is positioned between the first end portion 220 and the second end portion 230. A first fiber passageway 240 is formed by and between the first end portion 220 and the central portion 210. A second fiber passageway 250 is formed by and between the second end portion 230 and the central portion 210. The first fiber passageway 240 and the second fiber passageway 250 are structurally configured to form fiber pathways to guide/retain optical fibers, or other cable/wires. As shown in FIG. 1, the first fiber passageway 240 is structurally configured to align with the side edge fiber passageway 162 of the fiber entry portion 100 adjacent to the fiber bridge 200 such that one or more optical fibers can be routed from the fiber entry portion 100, through the fiber bridge 200, and into a second fiber entry portion 100. As shown in FIG. 1, the second fiber passageway 250 is structurally configured to align with an opening in a cassette mount 50 located adjacent to the fiber bridge 200 such that one or more optical fibers can be routed from the cassette mount 50, through the fiber bridge 200, and into a second cassette mount 50.

In this example, the first end portion 220 has a plurality of first end portion fiber retention portions 222 extending therefrom. In this example, the first end portion fiber retention portions 222 extend from the first end portion 220 in a direction substantially parallel to a front face of the fiber bridge 200. In this example, the second end portion 230 has a plurality of second end portion fiber retention portions 232 extending therefrom. In this example, the second end portion fiber retention portions 232 extend from the second end portion 230 in a direction substantially parallel to the front face of the fiber bridge 200. In this example, the central portion 210 has a plurality of central portion fiber retention portions 212 extending therefrom. In this example, the central portion fiber retention portions 212 extend from the central portion 210 in a direction substantially parallel to a front face of the fiber bridge 200. The fiber retention portions 212, 222, 232 help retain optical fibers in the first fiber passageway 240 and the second fiber passageway 250. In embodiments, one or more of the fiber retention portions 212, 222, 232 includes an angled end portion similar to fiber retention portions 112 shown in FIGS. 13-15.

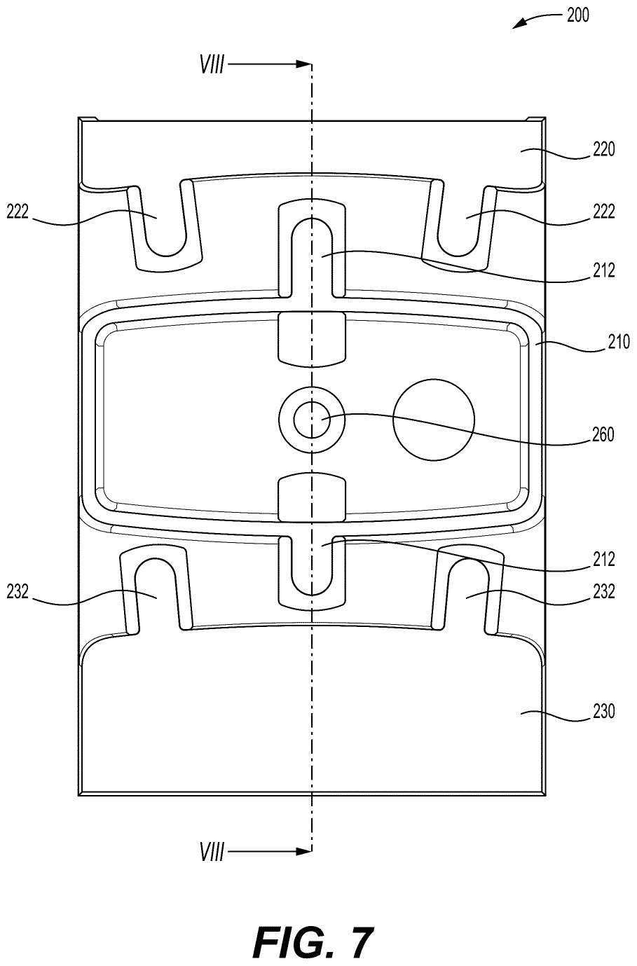

As shown in FIGS. 7-9, in this example, the fiber bridge 200 has an attachment portion, for example, a mounting opening, 260 for receiving a mounting hardware such as, for example, a screw or bolt.

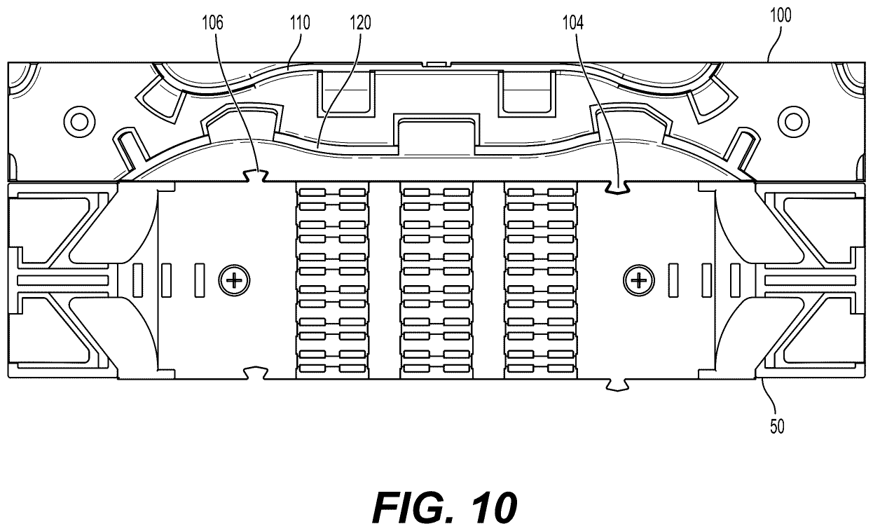

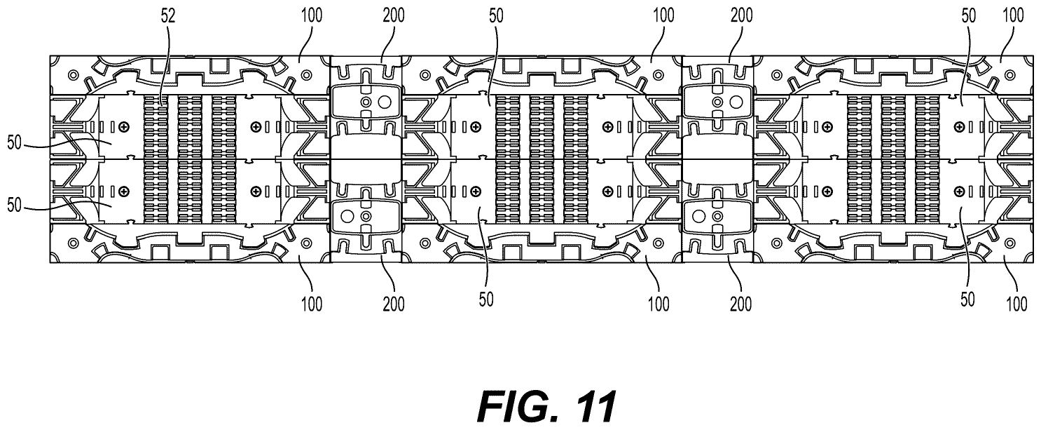

FIG. 10 shows a bottom edge of the fiber entry portion 100 attached to a top edge of a cassette mount 50. FIG. 11 shows one example of a plurality of fiber entry portions 100, a plurality of fiber bridges 200, and a plurality of cassette mounts 50 assembled in a fiber management assembly.

FIG. 12 shows the fiber management system 10 of FIG. 1 with a plurality of optical fibers routed between the various elements of the fiber management system 10. In this example, an optical fiber 31 is routed through the fiber management system 10 without being spliced or otherwise processed. The optical fiber 31 enters one of the cable guides 20, passes through one fiber entry portion 100, then three cassette mounts 50, then one fiber bridge 200, then three more cassette mounts 50, then another fiber entry portion 100, then another fiber bridge 200, and then out of the fiber management system 10 through a lower cable guide 20.

An optical fiber 32 is routed through the fiber management system 10 including through a cassette 40. The optical fiber 32 enters one of the cable guides 20, passes through one fiber entry portion 100, then three cassette mounts 50 and into a cassette 40, then out of the cassette 40, through three more cassette mounts 50, then another fiber entry portion 100, and then out of the fiber management system 10 through a lower cable guide 20.

An optical fiber 33 is routed into the fiber management system 10 and coiled in the fiber management system 10. The optical fiber 33 enters one of the cable guides 20, passes through one fiber entry portion 100, then five cassette mounts 50, then another fiber entry portion 100, then three more cassette mounts 50, then a fiber bridge 200, then two more cassette mounts 50, and then coiled on one of the cassette mounts 50.

An optical fiber 34 is routed into the fiber management system 10 and terminates in the fiber management system 10. The optical fiber 34 enters one of the cable guides 20, passes through one fiber entry portion 100, then one fiber bridge 200, then one cassette mount 50, and then ends in another cassette mounts 50.

The optical fibers 31, 32, 33, 34 show examples of how easily optical fibers can be routed between columns of cassette mounts while retaining the optical fibers neatly and securely. Also, due to spaces between the various fiber retention portions, any of the optical fibers can be easily removed from and/or rerouted within the fiber management system 10.

As discussed above, it may be desirable to provide a fiber routing arrangement that is structurally configured to facilitate routing of optical fibers in a fiber management system to enhance expansion of the fiber management system.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A fiber routing arrangement structurally configured to route optical fibers between modules of a fiber management system so as to enhance expansion of the fiber management system comprising:
a fiber entry portion including
a base portion;
a first edge fiber passage portion structurally configured to provide a passage for an optical fiber;
a second edge fiber passage portion structurally configured to provide a passage for the optical fiber;
a side edge fiber passage portion structurally configured to provide a passage for the optical fiber; and
a first guide portion structurally configured to guide the optical fiber in the fiber entry portion;
a fiber bridge portion including
a central portion structurally configured to be located between a first end portion and a second end portion;
a bridge first fiber passage portion between the first end portion and the central portion;
a bridge second fiber passage portion between the second end portion and the central portion;
wherein the first edge fiber passage portion is on a first edge portion of the base portion;
wherein the second edge fiber passage portion is on a second edge portion of the base portion;
wherein the second edge portion is opposite the first edge portion;
wherein the side edge fiber passage portion is on a side edge portion of the base portion, the side edge portion being an edge other than the first edge portion or the second edge portion;
wherein the side edge fiber passage portion is structurally configured to provide a passage for the optical fiber from the fiber entry portion to a location outside of the fiber entry portion through the side edge portion;
wherein the fiber bridge portion is structurally configured to be connected to a first module of a fiber management system located on a first side of the fiber bridge portion;
wherein the fiber bridge portion is structurally configured to be connected to a second module of the fiber management system located on a second side of the fiber bridge portion, the second side being opposite the first side;
wherein the bridge first fiber passage portion is structurally configured to facilitate passage of the optical fiber from between the first module and the second module;
wherein the bridge first fiber passage portion and the bridge second fiber passage portion are structurally configured to provide routing of the optical fiber between the first module and the second module of the fiber management system;
wherein the first edge fiber passage portion, the second edge fiber passage portion, and the side edge fiber passage portion are structurally configured to provide a passage for the optical fiber from an area outside of a fiber management system to an area of the fiber management system that is below the fiber entry portion, to provide a passage for the optical fiber from an area outside of the fiber management system to an area of the fiber management system that is located adjacent to the side edge fiber passage portion, and to provide a passage for the optical fiber from an area outside of a fiber management system to an area of the fiber management system that is above the fiber entry portion; and
wherein the fiber entry portion and the fiber bridge portion are structurally configured to provide routing of the optical fiber between the first module and the second module of the fiber management system so as to enhance expansion of the fiber management system.

2. The fiber routing system of claim 1, wherein the fiber entry portion further comprises a second guide portion structurally configured to guide the optical fiber in the fiber entry portion.

3. The fiber routing system of claim 1, wherein the fiber entry portion further comprises a first fiber retention portion structurally configured extend from the first guide portion and to retain the optical fiber on the fiber entry portion.

4. The fiber routing system of claim 1, wherein the first edge fiber passage portion is structurally configured to provide a passage for the optical fiber from the fiber entry portion to a location outside of the fiber entry portion through the first edge portion of the base portion.

5. The fiber routing system of claim 1, wherein the bridge second fiber passage portion is structurally configured to provide a passage for the optical fiber from between the first module and the second module.

6. The fiber routing system of claim 1, wherein the fiber bridge portion is structurally configured to be located between a first one of the fiber entry portion located on a first stack of modules and a second one of the fiber entry portion located on a second stack of modules.

7. The fiber routing system of claim 1, wherein the base portion is structurally configured as a base plate.

8. The fiber routing system of claim 1, wherein the first edge portion is structurally configured as a top edge of the base portion, the side edge portion is structurally configured as a side edge of the base portion, and the side edge portion is perpendicular to the top edge portion.

9. The fiber routing system of claim 1, wherein the fiber entry portion is structurally configured to be connected directly to a module at an end of a first stack of the modules.

10. A fiber routing arrangement structurally configured to route optical fibers between modules of a fiber management system so as to enhance expansion of the fiber management system comprising:
a fiber entry portion including
a first edge fiber passage portion structurally configured to provide a passage for an optical fiber;
a side edge fiber passage portion structurally configured to provide a passage for the optical fiber;
a fiber bridge portion including a bridge first fiber passage portion;
wherein the first edge fiber passage portion is on a first edge portion of the fiber entry portion;
wherein the side edge fiber passage portion is on a side edge portion of the fiber entry portion, the side edge portion being an edge other than the first edge portion;
wherein the side edge fiber passage portion is structurally configured to provide a passage for the optical fiber from the fiber entry portion to a location outside of the fiber entry portion;
wherein the fiber bridge portion is structurally configured to be connected to a first module of a fiber management system located on a first side of the fiber bridge portion;
wherein the fiber bridge portion is structurally configured to be connected to a second module of the fiber management system located on a second side of the fiber bridge portion, the second side being opposite the first side;
wherein the bridge first fiber passage portion is structurally configured to facilitate a passage for the optical fiber between the first module and the second module;
wherein the first edge fiber passage portion and the side edge fiber passage portion are structurally configured to provide a passage for the optical fiber from an area outside of a fiber management system to an area of the fiber management system that is below the fiber entry portion, to provide a passage for the optical fiber from an area outside of the fiber management system to an area of the fiber management system that is located adjacent to the side edge fiber passage portion, and to provide passage for the optical fiber from an area outside of a fiber management system to an area of the fiber management system that is above the fiber entry portion; and
wherein the fiber entry portion and the fiber bridge portion are structurally configured to provide routing of the optical fiber between the first module and the second module of the fiber management system so as to enhance expansion of the fiber management system.

11. The fiber routing system of claim 10, wherein the fiber entry portion further comprises a base portion, and the first edge fiber passage portion is on a first edge portion of the base portion.

12. The fiber routing system of claim 11, wherein the fiber edge portion further comprises a second edge fiber passage portion structurally configured to provide a passage for the optical fiber.

13. The fiber routing system of claim 12, wherein the second edge fiber passage portion is on a second edge portion of the base portion, and the second edge portion is opposite the first edge portion.

14. The fiber routing system of claim 10, wherein the fiber bridge portion further comprises a central portion structurally configured to be located between a first end portion and a second end portion, and
wherein the bridge first fiber passage portion is structurally configured between the first end portion and the central portion.

15. The fiber routing system of claim 14, wherein the fiber bridge portion further comprises a bridge second fiber passage portion structurally configured between the second end portion and the central portion.

16. A fiber entry portion structurally configured to provide an entry point for optical fibers into a fiber management system so as to enhance expansion of the fiber management system comprising:
a first edge fiber passage portion structurally configured to provide a passage for an optical fiber;
a side edge fiber passage portion structurally configured to provide a passage for the optical fiber;
wherein the first edge fiber passage portion is on a first edge portion of the fiber entry portion;
wherein the side edge fiber passage portion is on a side edge portion of the fiber entry portion, the side edge portion being an edge other than the first edge portion;
wherein the side edge fiber passage portion is structurally configured to provide a passage for the optical fiber from the fiber entry portion to a location outside of the fiber entry portion;
wherein the first edge fiber passage portion and the side edge fiber passage portion are structurally configured to provide a passage for the optical fiber from an area outside of a fiber management system to an area of the fiber management system that is below the fiber entry portion, to provide a passage for the optical fiber from an area outside of the fiber management system to an area of the fiber management system that is located adjacent to the side edge fiber passage portion, and to provide a passage for the optical fiber from an area outside of a fiber management system to an area of the fiber management system that is above the fiber entry portion; and
wherein the fiber entry portion is structurally configured to provide routing of the optical fiber between stacks of modules in the fiber management system so as to enhance expansion of the fiber management system.

17. The fiber entry portion of claim 16, wherein the fiber entry portion further comprises a base portion, and the first edge fiber passage portion is structurally configured to be on a first edge portion of the base portion.

18. The fiber entry portion of claim 16, wherein the fiber edge portion further comprises a second edge fiber passage portion structurally configured to provide a passage for the optical fiber.

19. The fiber entry portion of claim 18, wherein the second edge fiber passage portion is structurally configured on a second edge portion of the base portion, and the second edge portion is opposite the first edge portion.

20. The fiber entry portion of claim 18, wherein a second edge portion of the fiber entry portion is structurally configured to be connected directly to a module at an end of a first stack of the modules.

21. The fiber entry portion of claim 20, wherein the side edge portion of the fiber entry portion is structurally configured to be located adjacent to a fiber bridge located at a side of the first stack of the modules.
